(19) United States
(12) Patent Application Publication
(10) Pub. No.: US 2025/0391139 A1
(43) Pub. Date: Dec. 25, 2025

(54) VIDEO PROCESSING DEVICE, VIDEO PROCESSING METHOD, AND PROGRAM

(71) Applicant: SONY GROUP CORPORATION, TOKYO (JP)

(72) Inventor: TETSUYA KIKUKAWA, TOKYO (JP)

(21) Appl. No.: 18/878,912

(22) PCT Filed: Jun. 8, 2023
(86) PCT No.: PCT/JP2023/021294

§ 371 Date: Dec. 26, 2024

(30) Foreign Application Priority Data
Jul. 14, 2022 (JP) 2022-113366

(51) Int. Cl. G06T 19/20; G06T 7/73; G06T 15/08; G06T 15/20

(52) U.S. Cl. CPC G06T 19/20; G06T 7/73; G06T 15/08; G06T 15/205; G06T 2200/08; G06T 2207/10016; G06T 2207/20081; G06T 2207/20084; G06T 2207/30201; G06T 2219/2021

(57) ABSTRACT

A video processing device according to an aspect of the present disclosure includes: an estimation unit that estimates a 3D skeleton of a subject on the basis of multi-viewpoint images obtained by shooting the subject from a plurality of viewpoints; an application unit that applies a 3D skeleton of the subject estimated by the estimation unit to the subject included in other image different from the multi-viewpoint images and separated from a background in the image; and a generation unit that generates 3D data of a subject to which a 3D skeleton is applied by the application unit.

### FIELD

The present disclosure relates to a video processing device, a video processing method, and a program.

### BACKGROUND

Conventionally, there has been proposed a method of generating a 3D object in a viewing space by using information obtained by sensing a real 3D space, for example, multi-viewpoint images obtained by imaging a subject from different viewpoints, and generating video (volumetric video) that appears as if the object exists in the viewing space.

For example, in Patent Literature 1, a 3D shape of a subject is obtained on the basis of a depth map representing a distance from a camera to a surface of the subject.

In addition, a technique for estimating a skeleton of a person appearing in an image is known. For example, in Patent Literature 2, a skeleton of a person appearing in a two-dimensional image is estimated.

### CITATION LIST

### Patent Literature

Patent Literature 1: WO 2018/074252 A

Patent Literature 2: Japanese Patent No. 5784365

### SUMMARY

### Technical Problem

According to a conventional technique, a 3D shape of a subject can be accurately generated. However, since a 3D shape of a subject generated by a volumetric technique is based on an image obtained from a multi-viewpoint camera, it may be difficult to utilize the 3D shape. For example, in a case where there is some error in a 3D shape, it is necessary to manually modify images corresponding to the number of multi-viewpoint cameras, and thus a work load becomes very large. In addition, since it takes time and effort in shooting and generation, even when, for example, only a part of scenes of video including a generated 3D shape is shot again, a large amount of effort will be cost. For this reason, it is not easy to utilize a volumetric moving image including a 3D shape of a subject and the like under these circumstances.

Therefore, the present disclosure proposes a video processing device, a video processing method, and a program enabling a 3D shape of a subject to be easily utilized.

### Solution to Problem

In order to solve the above problems, a video processing device according to an aspect of the present disclosure includes: an estimation unit that estimates a 3D skeleton of a subject on the basis of multi-viewpoint images obtained by shooting the subject from a plurality of viewpoints; an application unit that applies a 3D skeleton of the subject estimated by the estimation unit to the subject included in other image different from the multi-viewpoint images and separated from a background in the image; and a generation unit that generates 3D data of a subject to which a 3D skeleton is applied by the application unit.

### BRIEF DESCRIPTION OF DRAWINGS

FIG. 1 is a diagram illustrating an outline of a flow of processing for generating a 3D model of a subject.

FIG. 2 is a diagram for explaining a method of estimating a skeleton of a subject.

FIG. 3 is a diagram for explaining processing of estimating a 3D skeleton of a subject.

FIG. 4 is a hardware block diagram illustrating an example of a hardware configuration of a video processing device according to an embodiment.

FIG. 5 is a flowchart illustrating an example of a flow of generation processing of volumetric video.

FIG. 6 is a diagram (1) for explaining video processing according to the embodiment.

FIG. 7 is a diagram (2) for explaining the video processing according to the embodiment.

FIG. 8 is a diagram (3) for explaining the video processing according to the embodiment.

FIG. 9 is a diagram illustrating a configuration example of the video processing device according to the embodiment.

FIG. 10 is a diagram (1) illustrating a first specific example of the video processing according to the embodiment.

FIG. 11 is a diagram (2) illustrating the first specific example of the video processing according to the embodiment.

FIG. 12 is a diagram (3) illustrating the first specific example of the video processing according to the embodiment.

FIG. 13 is a flowchart illustrating a procedure of the video processing according to the embodiment.

FIG. 14 is a flowchart illustrating a flow of data in the video processing according to the embodiment.

FIG. 15 is a diagram (1) illustrating a second specific example of the video processing according to the embodiment.

FIG. 16 is a diagram (2) illustrating the second specific example of the video processing according to the embodiment.

FIG. 17 is a diagram (3) illustrating the second specific example of the video processing according to the embodiment.

FIG. 18 is a flowchart showing a procedure of the second specific example of the video processing according to the embodiment.

FIG. 19 is a flowchart showing a data flow of the second specific example of the video processing according to the embodiment.

### DESCRIPTION OF EMBODIMENTS

In the following, embodiments of the present disclosure will be described in detail with reference to the drawings. In each of the following embodiments, the same parts are denoted by the same reference numerals to omit redundant description.

The present disclosure will be described following an order of items to be described below.

### 1. Embodiments of Present Disclosure

1-1. Explanation of Premise—Generation of 3D Model
1-2. Explanation of Premise—Generation of Volumetric Video
1-3. Explanation of Premise—Skeleton Estimation
1-4. Explanation of Premise—Estimation of 3D Skeleton
1-5. Explanation of Premise—Hardware Configuration of Video Processing Device
1-6. Explanation of Premise—Example of Flow of Video Processing
1-7. Outline of Video Processing according to Embodiment
1-8. Configuration of Video Processing Device according to Embodiment
1-9. Procedure of Video Processing according to Embodiment
1-10. Flow of Data in Video Processing according to Embodiment
1-11. Second Specific Example of Video Processing according to Embodiment
1-12. Procedure of Video Processing according to Second Specific Example of Embodiment
1-13. Flow of Data in Video Processing according to Second Specific Example of Embodiment

### 2. Application Examples of Present Disclosure

2-1. Production of Content
2-2. Experience in Virtual Space
2-3. Communication with Remote Place
2-4. Other Utilization Examples
2-5. Other Embodiments

### 3. Effects of Video Processing Device according to Present Disclosure

### 1. Embodiments of Present Disclosure

### (1-1. Explanation of Premise-Generation of 3D Model)

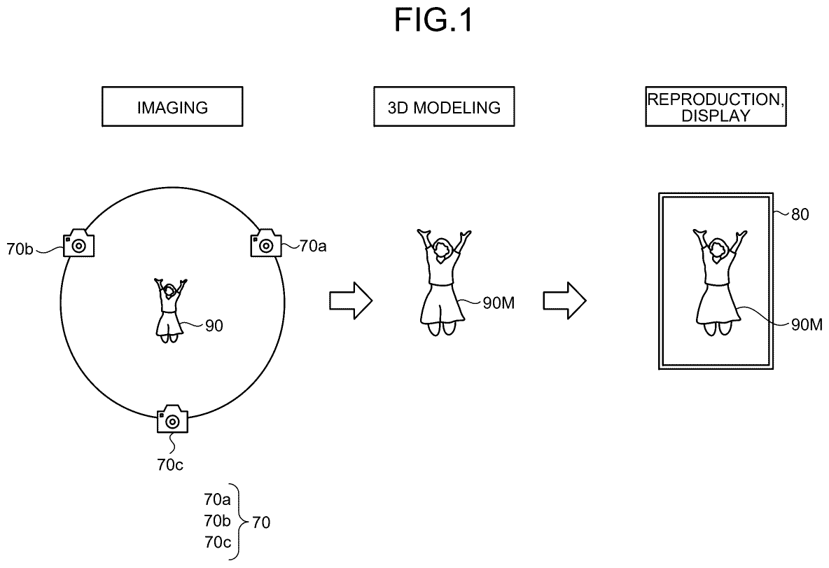

First, with reference to FIG. 1, description will be made of a flow of processing by a video processing device 100 to generate a 3D model 90M of a subject 90, the video processing device being applied the present disclosure. FIG. 1 is a diagram illustrating an outline of a flow of processing for generating a 3D model of a subject.

As illustrated in FIG. 1, the 3D model 90M of the subject 90 is generated through imaging of the subject 90 by a plurality of cameras 70 (a camera 70a, a camera 70b, a camera 70c) and through processing of generating the 3D model 90M having 3D information of the subject 90 by 3D modeling.

As illustrated in FIG. 1, the plurality of cameras 70 is arranged outside the subject 90 existing in the real world to face a direction of the subject 90 so as to surround the subject 90. FIG. 1 illustrates an example in which the number of the cameras is three, and the camera 70a, the camera 70b, and the camera 70c are arranged around the subject 90. Note that the number of the cameras 70 is not limited to three, and a larger number of cameras may be provided. Furthermore, a camera parameter 71a, a camera parameter 71b, and a camera parameter 71c of the camera 70a, the camera 70b, and the camera 70c, respectively, are acquired in advance by performing calibration. The camera parameter 71a, the camera parameter 71b, and the camera parameter 71c include internal parameters and external parameters of the camera 70a, the camera 70b, and the camera 70c, respectively. Note that the plurality of cameras 70 may acquire depth information indicating a distance to the subject 90.

The 3D modeling of the subject 90 is performed using multi-viewpoint images I synchronously captured by the three cameras 70a, 70b, and 70c from different viewpoints. Note that the multi-viewpoint images I include a two-dimensional image Ia captured by the camera 70a, a two-dimensional image Ib captured by the camera 70b, and a two-dimensional image Ic captured by the camera 70c. By this 3D modeling, the 3D model 90M of the subject 90 is generated on an image frame basis, the image being captured by the three cameras 70a, 70b, and 70c.

The 3D model 90M is generated by, for example, the method described in Patent Literature 1. Specifically, the 3D model 90M of the subject 90 is generated by cutting out a three-dimensional shape of the subject 90 using images from a plurality of viewpoints (e.g., silhouette images from a plurality of viewpoints) using Visual Hull.

The 3D model 90M expresses shape information indicating a surface shape of the subject 90 with, for example, polygon mesh data M expressed by connection between vertices. The polygon mesh data M has, for example, three-dimensional coordinates of vertices of a mesh and index information indicating which vertices are combined to form a triangle mesh. Note that the method of expressing a 3D model is not limited thereto, and the 3D model may be described by a so-called expression method for point cloud expressed by point position information. Color information data expressing a color of the subject 90 is generated as texture data T in association with these 3D shape data. The texture data includes a view independent texture having a constant color when viewed from any direction and a view dependent texture having a color changing depending on a viewing direction.

Since the generated 3D model 90M is often used by a calculator different from a calculator that has generated the 3D model 90M, the 3D model 90M is compressed (encoded) into a format suitable for transmission and accumulation. Then, the compressed 3D model 90M is transmitted to a calculator that uses the 3D model 90M.

### (1-2. Explanation of Premise—Generation of Volumetric Video)

Upon receiving the transmitted 3D model 90M, the calculator decompresses (decodes) the compressed 3D model 90M. Then, the calculator generates video (volumetric video) obtained by observing the subject 90 from an arbitrary viewpoint using the polygon mesh data M and the texture data T of the decompressed 3D model 90M.

Specifically, the polygon mesh data M of the 3D model 90M is projected onto an arbitrary camera viewpoint to perform texture mapping of attaching the texture data T representing colors and patterns to the projected polygon mesh data M.

The generated image is displayed on a display device 80 placed in a user's viewing environment. The display device 80 is, for example, a head mounted display, a spatial display, a mobile phone (smartphone), a television, a PC, or the like.

Note that, in the present embodiment, in order to simplify the description, it is assumed that the same apparatus (the video processing device 100) executes generation of the 3D model 90M and generation of the volumetric video obtained by deforming the generated 3D model 90M. Although in the description of the present disclosure, 3D expression of a subject is referred to as volumetric video, the volumetric video may be read as 3D data for expressing the subject.

### (1-3. Explanation of Premise—Skeleton Estimation)

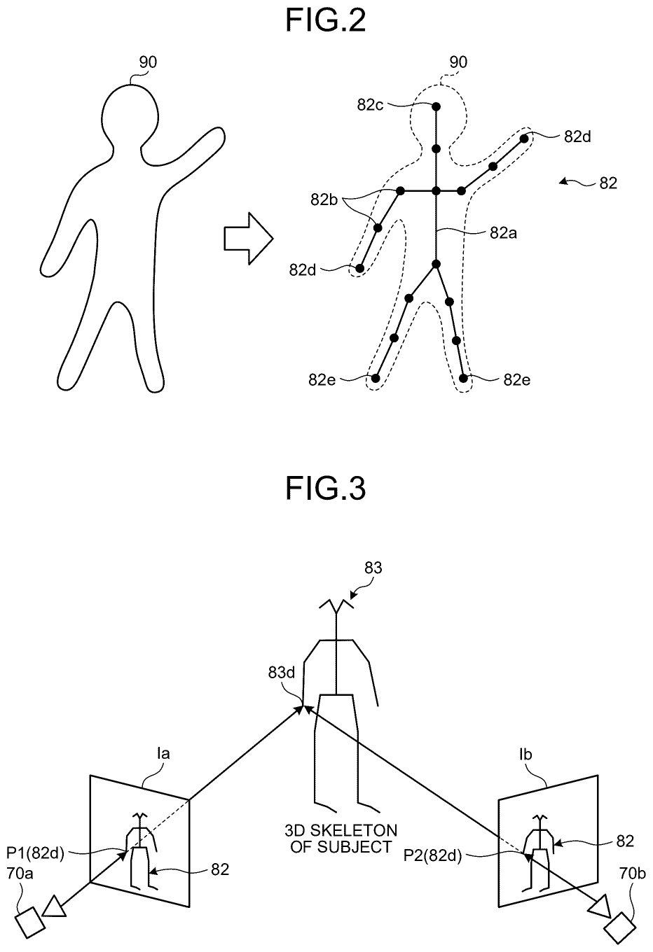

Next, a method of estimating a 2D skeleton 82 of a person who is the subject 90 from an image of the person will be described with reference to FIG. 2. FIG. 2 is a diagram for explaining a method of estimating a skeleton of the subject 90. Note that the 2D skeleton 82 represents a posture of the subject 90.

The 2D skeleton 82 is generated, for example, by the method described in Patent Literature 2. Specifically, the video processing device 100 creates in advance a database of a silhouette image of a person and segments representing a torso and limbs generated from the silhouette image. Then, the video processing device 100 collates a captured image with the database to estimate a shape of a skeleton, positions of joints, positions of finger tips, toes, a face, and the like.

In addition, also known is an example in which similar processing is performed using a neural network generated by machine learning using deep learning.

By performing such skeleton estimation, as illustrated in FIG. 2, a position and a shape of the 2D skeleton 82 are estimated from the image of the subject 90. The 2D skeleton 82 includes bones 82a, joints 82b, a head 82c, finger tips 82d, and toes 82e.

The bone 82a is a link that links structures (the Joints 82b, the head 82c, the finger tips 82d, the toes 82e) connected to each other. The joint 82b is a connection point of two different bones 82a. The head 82c indicates a position corresponding to a head of the subject 90. The finger tip 82d and the toe 82e indicate positions corresponding to a finger tip and a toe of the subject 90.

### (1-4. Explanation of Premise-Estimation of 3D Skeleton)

Next, a method for estimating a 3D skeleton 83 of the subject 90 will be described with reference to FIG. 3. FIG. 3 is a diagram for explaining processing of estimating a 3D skeleton of a subject.

The video processing device 100 estimates the 3D skeleton 83 of the subject 90 from a figure of the subject 90 appearing in each of a two-dimensional image Ia, a two-dimensional image Ib, and a two-dimensional image Ic on the basis of the 2D skeleton 82 estimated by the above method.

Specifically, as illustrated in FIG. 3, the video processing device 100 estimates the 3D skeleton 83 of the subject 90 from a position of the 2D skeleton 82 of the subject 90 appearing in arbitrary two images of the two-dimensional image Ia, the two-dimensional image Ib, and the two-dimensional image Ic, for example, the two-dimensional image Ia and the two-dimensional image Ib. Since an installation position of each camera and an orientation of an optical axis are already known by calibration performed in advance, when coordinates of the same part shown in each image are known, three-dimensional coordinates of the part can be estimated using the principle of triangulation.

The video processing device 100 extends a line segment connecting a point P1 indicating the finger tip 82d of the 2D skeleton 82 estimated from the two-dimensional image Ia and an optical center of the camera 70a. In addition, the video processing device 100 extends a line segment connecting a point P2 indicating the finger tip 82d of the 2D skeleton 82 estimated from the two-dimensional image Ib and an optical center of the camera 70b. The two extended lines intersect at a point P3 on the space. The point P3 represents a finger tip 83d of the 3D skeleton 83 of the subject 90.

The video processing device 100 performs similar processing on corresponding all joints, and all end points indicating the head 82c, the finger tips 82d, and the toes 82e of the 2D skeleton 82 estimated from the two-dimensional image Ia and the 2D skeleton 82 estimated from the two-dimensional image Ib. Consequently, the video processing device 100 can estimate the 3D skeleton 83 of the subject 90.

Note that, since a blind spot of the subject 90 is generated depending on layout of the plurality of cameras 70 (the camera 70a, the camera 70b, the camera 70c), the video processing device 100 performs the above processing on as many pairs of cameras as possible. Consequently, the video processing device 100 estimates every 3D skeleton 83 of the subject 90. For example, in the case of the present embodiment, the video processing device 100 desirably performs the above processing on each of the pair of the camera 70a and the camera 70b, the pair of the camera 70a and the camera 70c, and the pair of the camera 70b and the camera 70c.

### (1-5. Explanation of Premise—Hardware Configuration of Video Processing Device)

As described above, the video processing device 100 of the present embodiment generates the 3D model 90M and the 2D skeleton 82 of the subject 90. In addition, the video processing device 100 estimates the 3D skeleton 83 of the subject 90. Furthermore, the video processing device 100 deforms the posture of the 3D model 90M on the basis of an instruction from an operator. Note that the video processing device 100 is an example of the video processing device in the present disclosure.

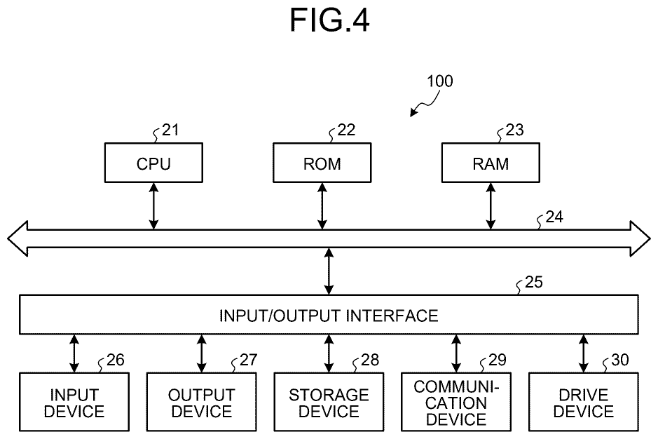

A hardware configuration of the video processing device 100 will be described with reference to FIG. 4. FIG. 4 is a hardware block diagram illustrating an example of a hardware configuration of the video processing device according to the embodiment.

In a computer illustrated in FIG. 4, a CPU 21, a ROM 22, and a RAM 23 are connected to each other via a bus 24. An input/output interface 25 is also connected to the bus 24. An input device 26, an output device 27, a storage device 28, a communication device 29, and a drive device 30 are connected to the input/output interface 25.

The input device 26 includes, for example, a keyboard, a mouse, a microphone, a touch panel, an input terminal, and the like. The output device 27 includes, for example, a display, a speaker, an output terminal, and the like. The display device 80 described above is an example of the output device 27. The storage device 28 includes, for example, a hard disk, a RAM disk, a nonvolatile memory, and the like. The communication device 29 includes, for example, a network interface and the like. The drive device 30 drives a removable medium such as a magnetic disk, an optical disk, a magneto-optical disk, or a semiconductor memory.

In the computer configured as described above, the CPU 21 loads, for example, a program stored in the storage device 28 into the RAM 23 via the input/output interface 25 and the bus 24 and executes the program, thereby performing the above-described series of processing. The RAM 23 also appropriately stores data and the like necessary for the CPU 21 to execute various kinds of processing.

The program executed by the computer can be applied, for example, by being recorded in a removable medium as a package medium or the like. In this case, the program can be installed in the storage device 28 via the input/output interface by attaching the removable medium to the drive device 30.

In addition, this program can also be provided via a wired or wireless transmission medium such as a local area network, the Internet, or digital satellite broadcasting. In this case, the program can be received by the communication device 29 and installed in the storage device 28.

### (1-6. Explanation of Premise-Example of Flow of Video Processing)

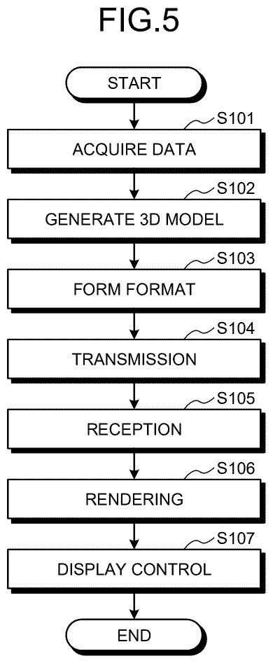

An outline of a flow of generation of a 3D model by the video processing device 100, i.e., generation of volumetric video will be described with reference to FIG. 5. FIG. 5 is a flowchart illustrating an example of a flow of generation processing of volumetric video.

As illustrated in FIG. 5, the video processing device 100 acquires image data for generating a 3D model of a subject (Step S101). The video processing device 100 generates a model having three-dimensional information of the subject on the basis of the image data for generating a 3D model of the subject (Step S102).

The video processing device 100 encodes a shape and texture data of the generated 3D model into a format suitable for transmission and accumulation (Step S103). The video processing device 100 transmits the encoded data (Step S104), and the calculator receives the transmitted data (Step S105). The calculator performs decoding processing and converts the data into a shape and texture data necessary for displaying. Furthermore, the calculator performs rendering using the shape and texture data (Step S106). Then, the calculator (alternatively, the display device 80 that displays volumetric video) displays the rendering result (Step $107).

As described above, the video processing device 100 that acquires and processes image data and the calculator that generates volumetric video may be the same apparatus.

### (1-7. Outline of Video Processing According to Embodiment)

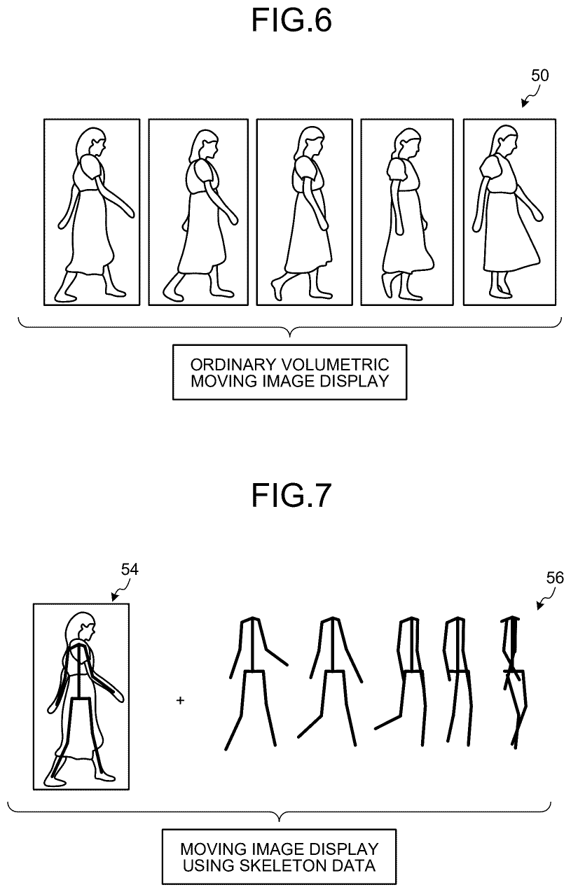

On the above premise, video processing according to the embodiment will be described. FIG. 6 is a diagram (1) for explaining the video processing according to the embodiment. In the embodiment, the video processing device 100 shoots a subject with a multi-viewpoint camera, and generates a volumetric moving image 50 of the subject using the above-described premised technique. Although not illustrated in FIG. 7, since the subject included in the volumetric moving image 50 is 3D data, the user can view the subject from any angle at the time of reproduction. In other words, the video processing device 100 separates the subject from the background, and generates the volumetric moving image 50 which is a moving image visible from various angles using only the subject as a 3D model.

Ordinarily, a volumetric moving image is generated on the basis of a plurality of moving images captured by a multi-viewpoint camera. For this reason, it is difficult to modify the moving image when it is desired to replace a part of the volumetric moving image (e.g., in a case where it is desired to again shoot only a latter half of a moving image obtained by shooting a dance scene, or the like) or when an error occurs in a part of the moving image. Therefore, the video processing device 100 generates a flexibly editable volumetric moving image by the video processing according to the embodiment. Consequently, the video processing device 100 can easily utilize a volumetric moving image.

This point will be described with reference to FIG. 7. FIG. 7 is a diagram (2) for explaining the video processing according to the embodiment.

In FIG. 7, it is assumed that volumetric video 54 including a subject shot by the multi-viewpoint camera is a frame in which no error or the like occurs in the video and which is suitable as volumetric video (hereinafter, such a frame is referred to as an “ideal frame”). At this time, the video processing device 100 performs rigging on the subject included in the volumetric video 54. In other words, the video processing device 100 generates skeleton data that is a 3D skeleton corresponding to the subject as described in the above-described premised technique, and embeds a rig for freely moving the skeleton data.

Then, the video processing device 100 moves the skeleton data along the frame using the rig. A skeleton data moving image 56 illustrated in FIG. 7 is a moving image representing how the subject is walking using skeleton data.

The video processing device 100 can obtain a volumetric moving image based on the skeleton data by performing retargeting processing of the video (reapplication to the video) on the basis of the skeleton data. The obtained volumetric moving image is, for example, a moving image similar to the volumetric moving image 50 illustrated in FIG. 6.

In other words, in contrast to a common technique of obtaining the volumetric moving image 50 by displaying a moving image using serial-numbered volumetric, in the video processing according to the embodiment, a volumetric moving image is obtained by displaying one static volumetric in serial numbers using the skeleton data. Specifically, the video processing device 100 enables volumetric expression of a moving image by serial-numbered skeleton data (the skeleton data moving image 56 in FIG. 7) and rigged still volumetric (the volumetric video 54 in FIG. 7).

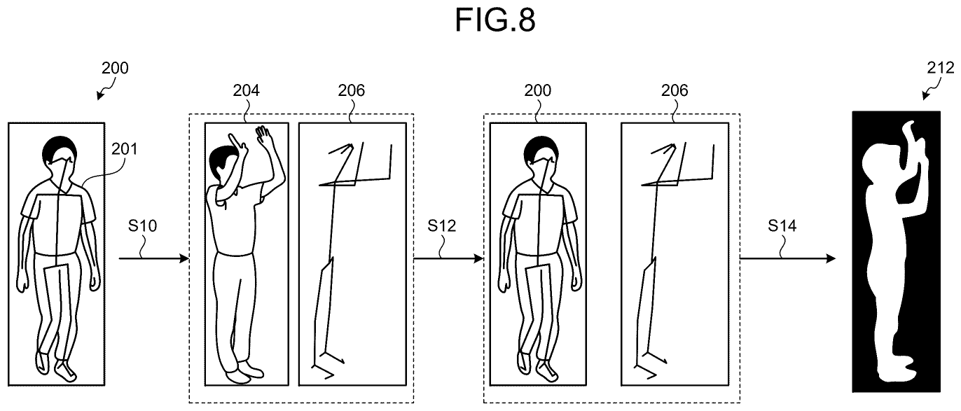

Such video processing will be specifically described with reference to FIG. 8. FIG. 8 is a diagram (3) for explaining the video processing according to the embodiment.

It is assumed that a frame 200 illustrated in FIG. 8 is one frame of volumetric video of a subject 201 and is an ideal frame. The video processing device 100 performs rigging on the frame 200 to generate a rig for moving skeleton data of the subject 201.

Thereafter, the video processing device 100 acquires a predetermined frame 204 in which the subject 201 is making another movement (Step S10). The frame 204 is a target frame from which the video processing device 100 intends to generate volumetric video.

The video processing device 100 generates skeleton data 206 corresponding to the frame 204 using, for example, markerless motion capture.

Then, the video processing device 100 retargets the frame 200 as volumetric (3D data) by using the obtained skeleton data 206 (Step S12). Specifically, the video processing device 100 deforms the volumetric to a shape corresponding to the skeleton data 206 using the rig embedded in the volumetric (Step S14).

A frame 212 illustrated in FIG. 8 is one frame of the volumetric video of the subject 201, and is the volumetric video generated from the skeleton data of movement corresponding to the frame 204. Thus, by generating one rigged volumetric, acquisition of skeleton data corresponding to a frame that is not volumetric enables the video processing device 100 to obtain new volumetric corresponding to the frame through the retargeting processing. Specifically, the video processing device 100 can obtain a volumetric silhouette moving image (a moving image which enables reproduction of movement of a person in 3D) by reprojecting deformed volumetric onto a target camera.

As described in the foregoing, although the video processing according to the embodiment causes work of putting a rig in an ideal frame to occur, in a subsequent frame, volumetric video is obtained by deforming a subject on the basis of skeleton data. Since the video processing according to the embodiment does not require generation of serial-numbered volumetric videos in all the frames, a data amount of the processing can be reduced. In addition, since the video processing according to the embodiment does not require a special video processing system, a volumetric moving image can be obtained without adding cost to system construction. From the foregoing, the video processing device 100 according to the embodiment can easily utilize a volumetric moving image.

### (1-8. Configuration of Video Processing Device According to Embodiment)

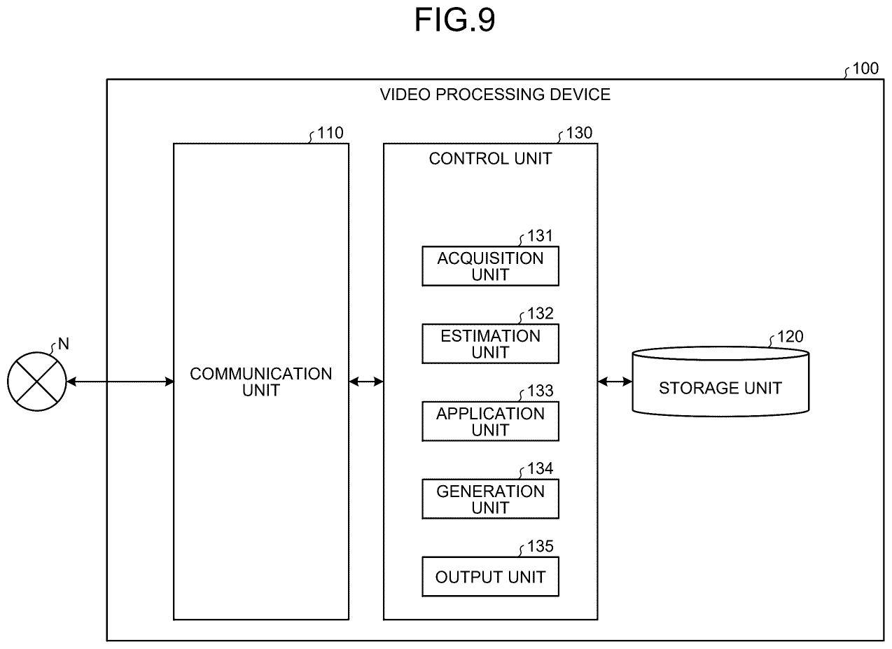

Next, a configuration of the video processing device 100 will be described. FIG. 9 is a diagram illustrating a configuration example of the video processing device 100 according to the embodiment.

As illustrated in FIG. 9, the video processing device 100 has a communication unit 110, a storage unit 120, and a control unit 130. Note that the video processing device 100 may have an input unit (e.g., a keyboard, a touch display, or the like) that receives various operations from an administrator who manages the video processing device 100, a user, or the like, and a display unit (e.g., a liquid crystal display or the like) for displaying various types of information.

The communication unit 110 is realized by, for example, a network interface card (NIC), a network interface controller, or the like. The communication unit 110 is connected to a network N in a wired or wireless manner, and transmits and receives information to and from a calculator, an external device and the like via the network N. The network N is realized by, for example, a wireless communication standard or system such as Bluetooth (registered trademark), the Internet, Wi-Fi (registered trademark), ultra wide band (UWB), and low power wide area (LPWA).

The storage unit 120 is realized by, for example, a semiconductor memory element such as a random access memory (RAM) or a flash memory, or a storage device such as a hard disk or an optical disk.

The storage unit 120 stores various types of information for performing the video processing according to the embodiment. For example, the storage unit 120 stores a program such as an application that functions in the video processing device 100, and various types of data (image data and the like) for use in processing.

The control unit 130 is realized by, for example, a central processing unit (CPU), a micro processing unit (MPU), GPU, or the like executing a program stored in the video processing device 100 using a random access memory (RAM) or the like as a work region. In addition, the control unit 130 is a controller, and may be realized by, for example, an integrated circuit such as an application specific integrated circuit (ASIC) or a field programmable gate array (FPGA). The control unit 130 corresponds to, for example, the CPU 21 illustrated in FIG. 3.

As illustrated in FIG. 9, the control unit 130 includes an acquisition unit 131, an estimation unit 132, an application unit 133, a generation unit 134, and an output unit 135.

The acquisition unit 131 acquires various types of information. For example, the acquisition unit 131 acquires image data that is a source of generating 3D data such as volumetric. Specifically, the acquisition unit 131 acquires a plurality of pieces of image data obtained by shooting with a large number of cameras surrounding a subject. Note that, in the following description, a plurality of pieces of image data obtained by shooting a subject from various angles at the same time may be referred to as “frames”. For example, one-second volumetric moving image includes 60 or 120 frames.

The estimation unit 132 estimates a 3D skeleton (skeleton data) of a subject on the basis of multi-viewpoint images obtained by shooting the subject from a plurality of viewpoints. As described above, various known techniques may be used for such estimation processing.

In addition, the estimation unit 132 estimates a 3D skeleton of the subject in a plurality of frames on the basis of a plurality of multi-viewpoint images continuously captured. The generation unit 134 to be described later can generate continuous volumetric video (volumetric moving image) as illustrated in FIG. 5 by generating volumetric video from each piece of skeleton data estimated on the basis of continuous frames.

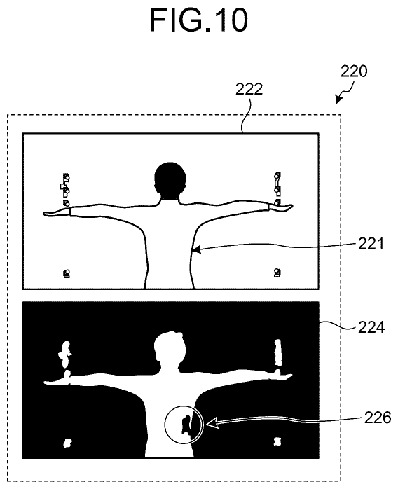

In addition, when second 3D data generated in advance (volumetric video generated by ordinary processing) has a defect, the estimation unit 132 estimates a 3D skeleton of the subject in a frame of a multi-viewpoint image corresponding to the second 3D data. In this case, the application unit 133 to be described later applies the estimated 3D skeleton of the subject to the subject in the frame of the multi-viewpoint image corresponding to the second 3D data. Furthermore, the generation unit 134 generates 3D data of the subject to which the 3D skeleton is applied instead of the second 3D data. Such processing will be described with reference to FIG. 10.

FIG. 10 is a diagram (1) illustrating a first specific example of the video processing according to the embodiment. A frame 220 illustrated in FIG. 10 shows image data 222 obtained by shooting a person 221 as a subject, and volumetric video 224 corresponding to the image data 222.

Since the volumetric video is utilized to express the subject in 3D, in the generation thereof, processing of separating the subject and the background from the captured image is performed. In the example of FIG. 10, processing of separating the person 221 and the background from the image data 222 is performed. The separation processing is performed by, for example, full view background separation using a background difference, machine learning, or the like. A silhouette image of only the subject is generated from the image by the separation processing.

In such separation, it is known that there is a possibility that a silhouette part may have a defect regardless of a processing method. Specifically, determining a part of the silhouette part to be a background may cause a problem of puncturing a resultantly generated volumetric shape. The example of FIG. 10 shows a state where a part indicated by a region 226 is erroneously recognized as the background in the volumetric video 224, and a hole is formed.

When a frame with a hole is generated, it may be necessary to manually modify the silhouette. However, since the volumetric video is generated on the basis of as large the number of pieces of image data as, e.g. 50 cameras, cost for the work becomes very large.

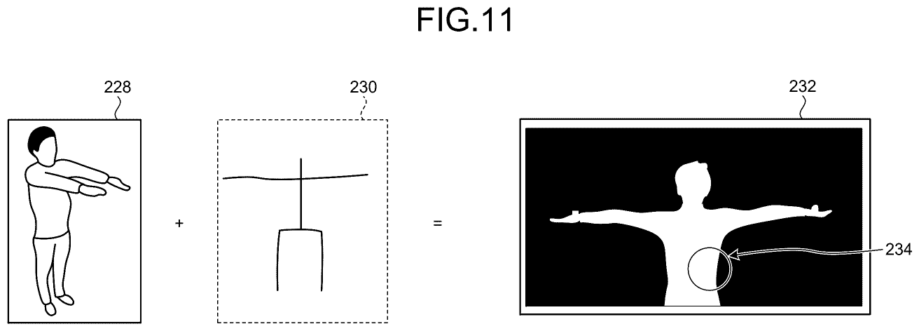

Therefore, the video processing device 100 solves the above problem by processing to be described below. This point will be described with reference to FIG. 11. FIG. 11 is a diagram (2) illustrating the first specific example of the video processing according to the embodiment.

In FIG. 11, the generation unit 134 generates volumetric video on the basis of an ideal frame 228, and puts a rig in the video. Thereafter, when detecting a defective frame (e.g., a frame with a hole), the estimation unit 132 estimates skeleton data 230 in such a frame.

Then, the application unit 133 retargets the estimated skeleton data 230 to the volumetric including the rig and adjusts a posture. The generation unit 134 generates a silhouette 232 by reprojecting the retargeted volumetric onto a camera by which a silhouette is captured as if a hole is made. The silhouette 232 has no holes in a region 234 since the volumetric has been reconstructed from the skeleton data 230 utilizing the rig of the ideal frame 228. As a result, the generation unit 134 can obtain a silhouette having no defect such as a hole.

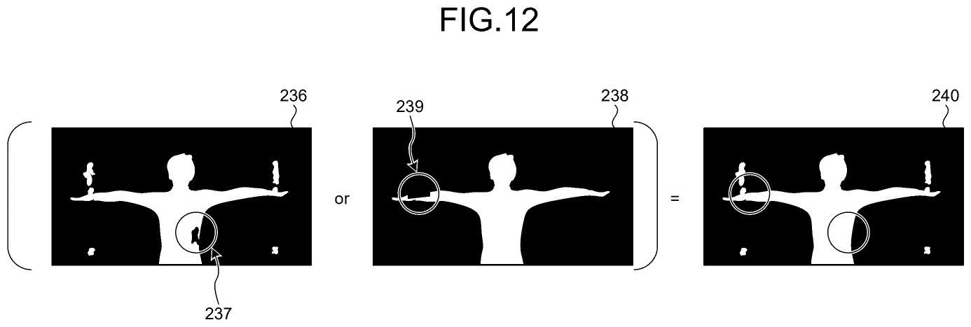

In addition, the video processing device 100 can obtain a silhouette without a defect by a different method. Specifically, the generation unit 134 generates third 3D data by taking a logical sum of the second 3D data and the 3D data of the subject. This point will be described with reference to FIG. 12. FIG. 12 is a diagram (3) illustrating the first specific example of the video processing according to the embodiment.

A frame 236 illustrated in FIG. 12 is a frame with a hole in a region 237 as a part of the silhouette. When such a frame 236 is corrected by the above processing, although there is no hole in the region 237, other defect may occur. For example, a frame 238 illustrated in FIG. 12 is a frame having a defect (noise), in which there is no hole in a part corresponding to the region 237 but an arm part of the subject is missing.

In such a case, the generation unit 134 may take a logical sum (OR operation) of both the frames and determine, as the subject, a part including the data of the subject in any of the frames. As a result, the generation unit 134 can obtain a frame 240 without holes or noise. In other words, since there is a case where a silhouette generated by the retargeting processing as in the frame 238 is cut at a part other than the hole, the generation unit 134 can perform the logical sum operation and generate a silhouette using only an appropriate part of the data.

Since this processing eliminates a need for the video processing device 100 to manually modify a silhouette, it is possible to generate volumetric video without a defect such as a hole while reducing the work load.

Returning to FIG. 9, the description will be continued. The application unit 133 applies the 3D skeleton of the subject estimated by the estimation unit 132 to a subject included in other image different from the multi-viewpoint image and separated from the background in the image. Other image different from the multi-viewpoint image is, for example, image data in a frame different from the multi-viewpoint image (a frame having different shooting timing).

On the basis of a rig applied to the subject included in other image, the application unit 133 applies the 3D skeleton of the subject to that subject. In other words, the application unit 133 retargets a 3D model (volumetric) with a rig.

The generation unit 134 generates 3D data of the subject to which the 3D skeleton is applied by the application unit 133. Specifically, the generation unit 134 generates the 3D data (volumetric) of the subject on the basis of a silhouette generated by applying (retargeting) the 3D skeleton and reprojecting the 3D skeleton onto the camera.

For example, the generation unit 134 generates a volumetric moving image of a subject as 3D data on the basis of a 3D skeleton (time-series skeleton data or that continuous in motion) of the subject in a plurality of frames.

The output unit 135 outputs the 3D data generated by the generation unit 134. For example, the output unit 135 outputs the volumetric moving image, which is the 3D data, to the display device 80 or the like for use by the user, thereby providing the moving image to the user.

### (1-9. Procedure of Video Processing According to Embodiment)

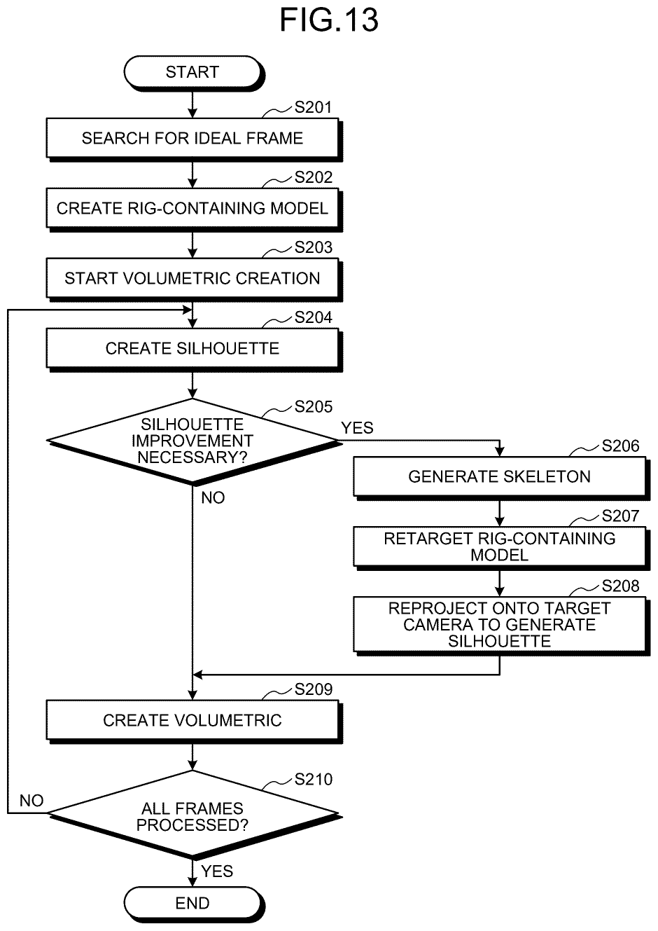

Next, a procedure of the video processing according to the embodiment will be described with reference to FIG. 13. FIG. 13 is a flowchart illustrating a procedure of the video processing according to the embodiment.

As illustrated in FIG. 13, the video processing device 100 searches for an ideal frame among frames acquired from the multi-viewpoint camera (Step S201). Such processing may be performed, for example, visually by the administrator of the video processing device 100, or may be automatically performed using a machine learning model or the like for determining an ideal frame.

Subsequently, the video processing device 100 creates a rig-containing model for the subject in the ideal frame (Step S202). Then, the video processing device 100 starts volumetric creation processing related to the rig-containing model (Step S203).

First, the video processing device 100 separates the subject included in the frame from the background and creates a silhouette (Step S204). Then, the video processing device 100 determines whether or not improvement is necessary for the created silhouette (Step S205). For example, the administrator of the video processing device 100 visually determines whether the silhouette has a hole or includes some noise.

Then, when the administrator of the video processing device 100 determines that silhouette improvement is necessary (Step S205; Yes), the video processing device 100 performs skeleton estimation for the subject of the frame and generates skeleton data (Step S206).

Subsequently, the video processing device 100 retargets the rig-containing model to the generated skeleton data (Step S207). Then, the video processing device 100 reprojects the retargeted data onto the target camera to generate a silhouette of the frame (Step S208). As illustrated in FIG. 11 or FIG. 12, such a silhouette is a silhouette in which defects such as holes and noise are eliminated.

When determination is made that no silhouette improvement is necessary in Step S205 (Step S205; No), or when the silhouette newly generated in Step S208 is acquired, the video processing device 100 creates volumetric on the basis of the silhouette (Step S209).

The video processing device 100 determines whether or not the above processing has been performed for all the frames to be processed (Step S210). In a case where not all the frames have been processed (Step S210; No), the video processing device 100 repeats the processing from Step S204. On the other hand, in a case where all the frames have been processed (Step S210; Yes), the video processing device 100 ends the volumetric generation processing.

### (1-10. Flow of Data in Video Processing According to Embodiment)

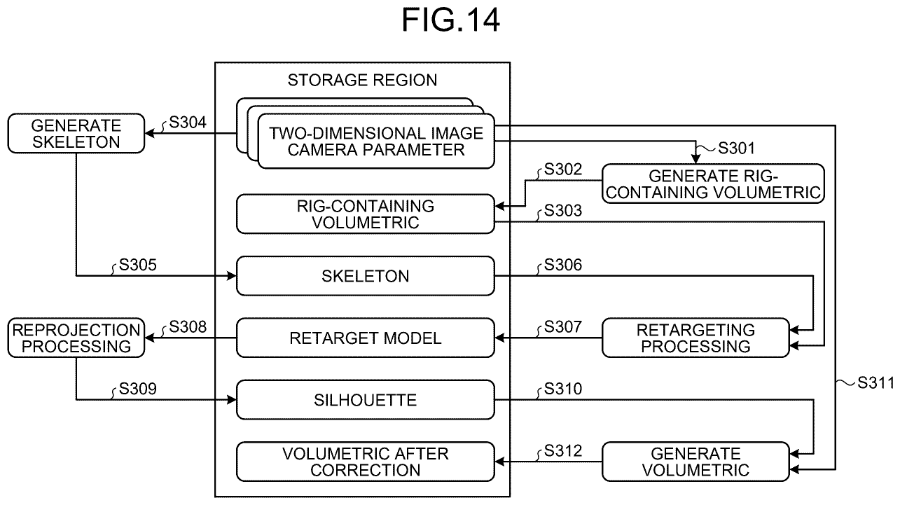

Next, a flow of data in the video processing according to the embodiment will be described with reference to FIG. 14. FIG. 14 is a flowchart illustrating a flow of data in the video processing according to the embodiment.

First, the video processing device 100 accesses a predetermined storage region (e.g., the storage unit 120) to acquire a two-dimensional image and a camera parameter obtained by shooting with the multi-viewpoint camera (Step S301). The video processing device 100 generates rig-containing volumetric from an ideal frame among the acquired data, and stores the generated volumetric in the storage region (Step S302). In addition, the video processing device 100 transmits the rig-containing volumetric to a retargeting processing unit so as to be used in processing at a subsequent step (Step S303).

In addition, the video processing device 100 generates skeleton data of a subject included in a two-dimensional image (frame) in which a silhouette having a defect is generated (Step S304), and stores the skeleton data in the storage region (Step S305). Furthermore, the video processing device 100 transmits the skeleton data to the retargeting processing unit so that the skeleton data can be used in the processing at the subsequent step (Step S306).

On the basis of the skeleton data, the video processing device 100 performs the retargeting processing of the volumetric of the rig-containing model, generates a retarget model, and stores the retarget model in the storage region (Step S307).

The video processing device 100 reprojects the retarget model onto the multi-viewpoint camera (Step S308), newly generates a silhouette, and stores the silhouette in the storage region (Step S309). Then, the video processing device 100 acquires the newly generated silhouette (Step S310) and acquires the camera parameter and the like of the multi-viewpoint camera (Step S311) to generate volumetric on the basis of the acquired information. The video processing device 100 stores the generated volumetric after the correction in the storage region (Step S312), and ends the processing.

### (1-11. Second Specific Example of Video Processing According to Embodiment)

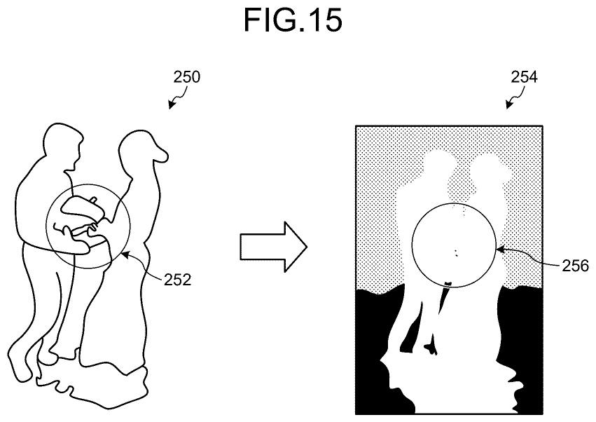

Next, a second specific example of the video processing according to the embodiment will be described with reference to FIG. 15 and the subsequent drawings. FIG. 15 is a diagram (1) illustrating the second specific example of the video processing according to the embodiment.

The second specific example shows an example in which there is a plurality of subjects to be targets for the processing of the volumetric generation. In a content such as a moving image, since it is a common practice to collectively shoot even a plurality of subjects, it is desirable that volumetric can be appropriately generated even in a case where there is a plurality of subjects.

The example illustrated in FIG. 15 shows a situation of shooting a plurality of subjects 250. In this case, when a region 252 in which the bodies of the plurality of subjects 250 overlap is silhouetted, occlusion is likely to occur. A frame 254 illustrated in FIG. 15 is an example of image data obtained by shooting the plurality of subjects 250. In a region 256 corresponding to the region 252, occlusion occurs due to overlapping of the plurality of subjects 250, and it is difficult to determine which part belongs to which subject in a case where the region is silhouetted.

In other words, video processing in a case where there is a plurality of subjects has the following problems. First, when a plurality of subjects is collectively generated as an object file, it is difficult to perform modification such as fine adjustment of a position of each subject after the generation. While in a case where the subjects are separated from each other, no problem occurs, in a case where the subjects are close to each other, occlusion occurs between their bodies to lower accuracy of a volumetric shape. Note that, in order to solve these problems, it is conceivable to individually shoot each subject. However, in this case, another problem such as difficulty in matching positions and timings of the respective subjects occurs. For example, in shooting a dance scene, it is difficult for one performer to dance in a scene in which a plurality of performers should dance, in the same manner as in a case where other performers are present.

Therefore, the video processing device 100 according to the embodiment solves the above problems by processing to be described below. Specifically, the estimation unit 132 according to the video processing device 100 estimates a 3D skeleton of each of a plurality of subjects on the basis of a multi-viewpoint image including the plurality of subjects. Then, the application unit 133 applies the 3D skeleton of each of the plurality of subjects to each subject included in other image different from the multi-viewpoint image. Furthermore, the generation unit 134 generates 3D data of each subject to which the 3D skeleton is applied.

Specifically, the video processing device 100 collectively shoots the plurality of subjects, and generates rig-containing volumetric for each subject. Then, in a case where occlusion occurs due to a plurality of subjects nearing to each other in a predetermined frame, the rig-containing volumetric is retargeted to obtain each silhouette. The video processing device 100 may collectively model the plurality of subjects on the basis of the obtained silhouette, or may separately model each subject. In other words, the generation unit 134 according to the video processing device 100 may generate 3D data in which the respective subjects to which the 3D skeleton is applied are integrated into one. With this processing, the video processing device 100 can generate appropriate volumetric even in a frame including a plurality of subjects.

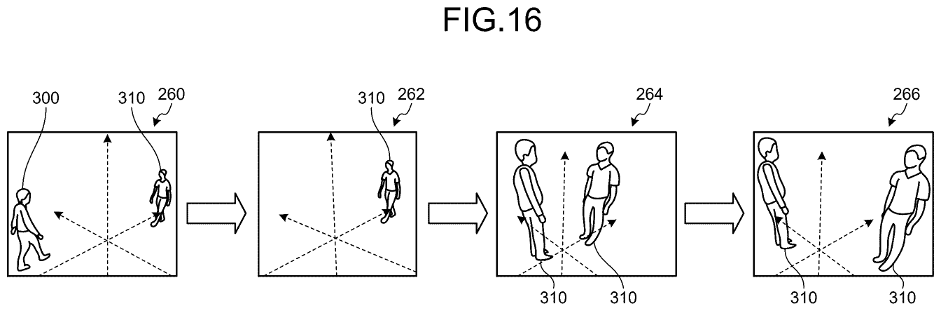

Such processing will be described with reference to FIG. 16. FIG. 16 is a diagram (2) illustrating the second specific example of the video processing according to the embodiment.

A frame 260 illustrated in FIG. 16 includes a subject 300 and a subject 310. In this case, the video processing device 100 separates the subject by manual or automatic processing. A frame 262 illustrated in FIG. 16 shows a situation in which the video processing device 100 separates only the subject 310 from the frame 260. Then, the video processing device 100 generates rig-containing volumetric of the subject 310. Although not illustrated, the video processing device 100 generates rig-containing volumetric corresponding to the subject 300 from a frame into which only the subject 300 is separated.

Thus, since the video processing device 100 can apply the video processing described above by obtaining the separated rig-containing volumetric, it is also possible to newly generate video or the like in which the subject 300 or the subject 310 is arbitrarily positioned. For example, a frame 264 and a frame 266 illustrated in FIG. 16 show examples in which the video processing device 100 arbitrarily changes the positions and sizes of the subject 300 and the subject 310.

Thus, even in a frame including a plurality of subjects, the video processing device 100 can retarget each subject by separating the subjects once and generating each rig-containing volumetric, so that volumetric of the plurality of subjects can be generated more flexibly. For example, the administrator of the video processing device 100 can manually divide the subjects included in the frame, and generate volumetric for each subject to perform rigging processing thereon, resulting in obtaining volumetric of each subject. Consequently, since the video processing device 100 enables flexible generation of video such as arbitrarily arranging each volumetric, it is possible to meet a request for fine adjustment of a position after shooting a dance scene or the like.

Note that the video processing device 100 may automatically separate a subject using a machine learning model or the like and generate rig-containing volumetric. Since it is not realistic to manually divide the subjects after visually checking all the frames, automation has a great advantage.

Note that the video processing device 100 can also adopt a different method as a method of generating one silhouette from a plurality of silhouette images. Specifically, in a case where a 3D skeleton of each of the plurality of subjects is applied to each subject, the application unit 133 according to the video processing device 100 may specify data of an application destination subject by taking a logical product of data corresponding to a subject separated from the background between a plurality of images including at least one subject.

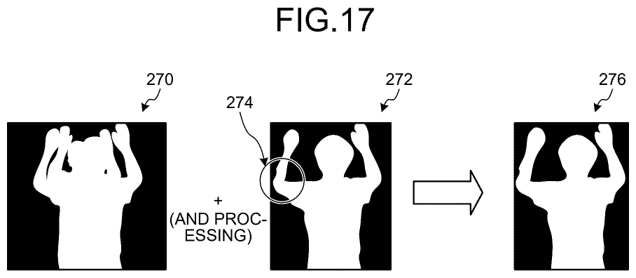

This point will be described with reference to FIG. 17. FIG. 17 is a diagram (3) illustrating the second specific example of the video processing according to the embodiment.

A frame 270 illustrated in FIG. 17 shows a situation in which silhouettes of a plurality of subjects overlap. In addition, a frame 272 shows a situation in which a silhouette is newly generated only for one subject on the basis of rig-containing volumetric. Note that, as also described in FIG. 12, in a region 274 of the frame 272, noise is generated in the retargeting processing, and partial missing is observed.

In this case, the video processing device 100 takes a logical product (AND processing) of parts determined as silhouettes in the frame 270 and the frame 272. Then, since only the parts determined to be silhouettes in both frames are extracted, the video processing device 100 can specify an appropriate silhouette of one person like a frame 276. In this case, the generation unit 134 according to the video processing device 100 may correct a shape of the specified subject and generate 3D data of the subject on the basis of a 3D skeleton after the correction. For example, the generation unit 134 can perform known morphological processing or the like on the silhouette of the frame 276 to correct the shape of the silhouette. Specifically, the generation unit 134 can bring a shape of a silhouette closer to the original shape by performing the morphological processing on the silhouette tending to be expressed thinner than the original shape as a result of taking the logical product. Note that, even in a case where an extra shape due to noise occurs as a result of performing the AND processing, or other case, it is assumed that such a part of the extra shape is not a problem since the part is cut by a camera shooting from other angle.

### (1-12. Procedure of Video Processing According to Second Specific Example of Embodiment)

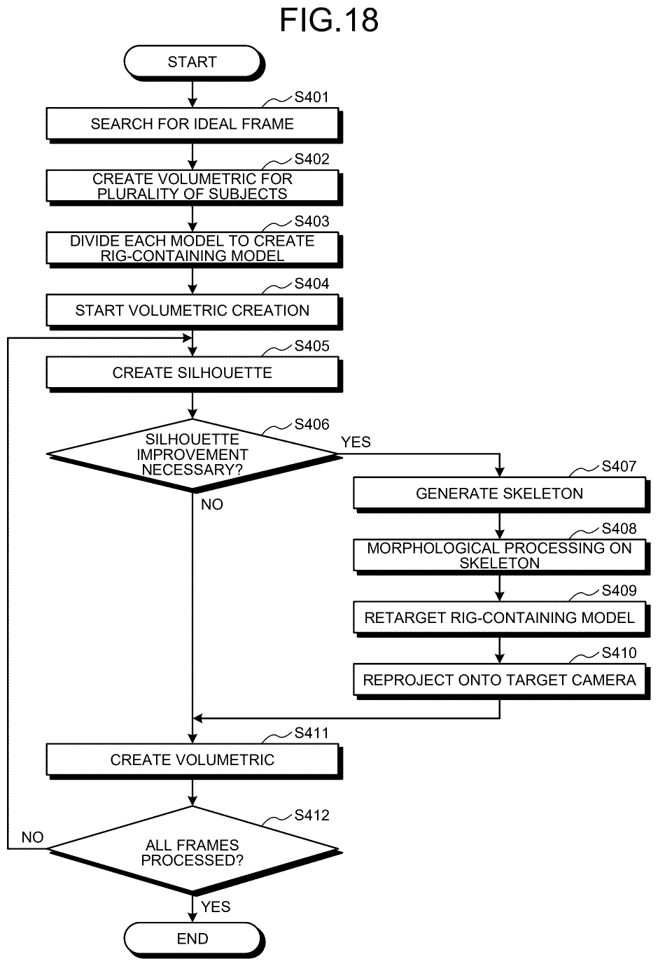

Next, a procedure of the second specific embodiment according to the embodiment will be described with reference to FIG. 18. FIG. 18 is a flowchart showing a procedure of the second specific example of the video processing according to the embodiment.

As illustrated in FIG. 18, the video processing device 100 searches for an ideal frame among frames acquired from the multi-viewpoint camera (Step S401).

Subsequently, the video processing device 100 creates volumetric for each of a plurality of subjects in the ideal frame (Step S402). Furthermore, the video processing device 100 divides each model (volumetric of each subject) to generate a rig-containing model (Step S403). Then, the video processing device 100 starts the volumetric creation processing for the plurality of subjects (Step S404).

First, the video processing device 100 separates the subject included in the frame from the background and creates a silhouette (Step S405). Then, the video processing device 100 determines whether or not improvement is necessary for the created silhouette (Step S406).

Then, when the administrator of the video processing device 100 determines that silhouette improvement is necessary (Step S406; Yes), the video processing device 100 performs skeleton estimation for the subject in the frame and generates skeleton data (Step S407).

Subsequently, the video processing device 100 performs the morphological processing on the generated skeleton data to correct the shape (Step S408). Subsequently, the video processing device 100 retargets the rig-containing model on the basis of the corrected skeleton data (Step S409). Then, the video processing device 100 reprojects the retargeted data onto the target camera (Step S410). Note that the video processing device 100 may perform the morphological processing or the like for correcting the generated silhouette after the reprojection.

When the video processing device 100 determines that no silhouette improvement is necessary in Step S406 (Step S406; No), or when the silhouette newly generated in Step S410 is acquired, volumetric is created on the basis of the silhouette (Step S411).

The video processing device 100 determines whether or not the above processing has been performed for all the frames to be processed (Step S412). In a case where not all the frames have been processed (Step S412; No), the video processing device 100 repeats the processing from Step S405. On the other hand, in a case where all the frames have been processed (Step S412; Yes), the video processing device 100 ends the volumetric generation processing.

### (1-13. Flow of Data in Video Processing According to Second Specific Example of Embodiment)

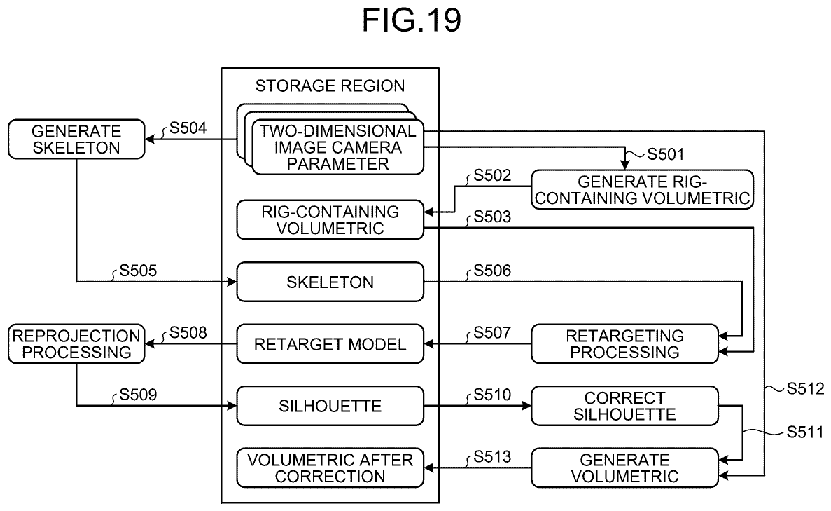

Next, a flow of data in the video processing according to the second example of the embodiment will be described with reference to FIG. 19. FIG. 19 is a flowchart showing the data flow of the second specific example of the video processing according to the embodiment.

First, the video processing device 100 accesses a predetermined storage region to acquire a two-dimensional image and a camera parameter obtained by shooting with the multi-viewpoint camera (Step S501). The video processing device 100 generates rig-containing volumetric from an ideal frame among the acquired data, and stores the generated volumetric in the storage region (Step S502). In addition, the video processing device 100 transmits the rig-containing volumetric to the retargeting processing unit so as to be used in the processing at the subsequent step (Step S503).

Furthermore, the video processing device 100 generates skeleton data of a subject included in a two-dimensional image (frame) in which a silhouette having a defect is generated (Step S504), and stores the skeleton data in the storage region (Step S505). Furthermore, the video processing device 100 transmits the skeleton data to the retargeting processing unit so that the skeleton data can be used in the processing at the subsequent step (Step S506).

On the basis of the skeleton data, the video processing device 100 performs the retargeting processing of the volumetric of the rig-containing model, generates a retarget model, and stores the retarget model in the storage region (Step S507).

The video processing device 100 reprojects the retarget model onto the multi-viewpoint camera (Step S508), newly generates a silhouette, and stores the silhouette in the storage region (Step S509). Then, the video processing device 100 acquires the newly generated silhouette (Step S510), and performs correction such as the morphological processing. Then, the video processing device 100 acquires the corrected silhouette (Step S511), acquires the camera parameter and the like of the multi-viewpoint camera (Step S512), and generates volumetric on the basis of the acquired information. The video processing device 100 stores the generated volumetric after the correction in the storage region (Step S513), and ends the processing.

### 2. Application Example of Present Disclosure

### (2-1. Production of Content)

For example, the video processing device 100 may synthesize a 3D model 90M of the subject 90 generated by the video processing device 100 and a 3D model managed by other server to produce a video content. Furthermore, for example, in a case where background data exists in an imaging device such as Lidar, by combining the 3D model 90M of the subject 90 and the background data, the video processing device 100 can produce a content as if the subject 90 is at a place indicated by the background data.

### (2-2. Experience in Virtual Space)

For example, the video processing device 100 can arrange the subject 90 that is volumetric in a virtual space that is a place where a user acts as an avatar to communicate. In this case, the user becomes an avatar to be able to view a live-action subject 90 in the virtual space.

(2-3. Communication with Remote Place)

For example, the video processing device 100 transmits the 3D model 90M of the subject 90 to a remote place, thereby allowing a user at the remote place to view the 3D model 90M of the subject 90 through a reproduction device at the remote place. For example, the video processing device 100 can create a situation in which the subject 90 and a user at a remote place communicate with each other in real time by transmitting the 3D model 90M of the subject 90 in real time. For example, a case where the subject 90 is a teacher and the user is a student, a case where the subject 90 is a doctor and the user is a patient, and the like can be assumed.

### (2-4. Other Utilization Examples)

For example, the video processing device 100 can also generate free viewpoint video of sports or the like on the basis of the 3D models 90M of the plurality of subjects 90. The user can also distribute his/her generated volumetric to a distribution platform. Thus, the contents of the embodiments described in the present specification can be applied to various techniques and services.

### (2-5. Other Embodiments)

The processing according to the above-described embodiments may be performed in various different modes other than the above-described respective embodiments.

Among the processing described in the above embodiments, it is possible to manually perform all or a part of the processing described as being performed automatically, or it is possible to automatically perform, by a known method, all or a part of the processing described as being performed manually. Furthermore, the processing procedures, the specific names, and the information including various types of data and parameters shown in the above document and drawings can be arbitrarily changed unless otherwise specified. For example, the various types of information illustrated in the respective drawings are not limited to the illustrated information.

In addition, each component of each device illustrated in the drawings is functionally conceptual, and is not necessarily configured physically as illustrated in the drawings. Specifically, a specific mode of distribution and integration of each device is not limited to those illustrated, and all or a part thereof can be functionally or physically distributed and integrated on an arbitrary unit basis according to various loads, a use situation, and the like. For example, the application unit 133 and the generation unit 134 may be integrated.

In addition, the above-described embodiments and modifications can be appropriately combined within a range in which the processing contents do not contradict each other.

In addition, the effects described in the present specification are examples only and are not limited, and other effects may be provided.

### 3. Effects of Video Processing Device According to Present Disclosure

As described above, the video processing device according to the present disclosure (the video processing device 100 in the embodiment) includes the estimation unit (the estimation unit 132 in the embodiment), the application unit (the application unit 133 in the embodiment), and the generation unit (the generation unit 134 in the embodiment). The estimation unit estimates a 3D skeleton of a subject on the basis of multi-viewpoint images obtained by shooting the subject from a plurality of viewpoints. The application unit applies a 3D skeleton of the subject estimated by the estimation unit to the subject included in other image different from the multi-viewpoint images and separated from a background in the image. The estimation unit generates 3D data of a subject to which a 3D skeleton is applied by the application unit.

Thus, the video processing device according to the present disclosure estimates a 3D skeleton of a subject as a 3D data (volumetric) generation target, and generates 3D data on the basis of the estimated 3D skeleton. This eliminates a need for the video processing device to generate serial-numbered volumetric videos in all the frames, so that a data amount of the processing can be reduced. In addition, since such video processing does not require a special video processing system, appropriate 3D data can be obtained without adding cost to system construction. As a result, the video processing device can realize simple utilization of a 3D shape.

Furthermore, on the basis of a rig attached to the subject included in the other image, the application unit applies a 3D skeleton of the subject to the subject.

Thus, the video processing device generates a rig-containing model in an ideal frame, and applies the 3D skeleton to the subject on the basis of the rig, so that it is possible to generate volumetric in accordance with various movements of the subject.

Furthermore, the estimation unit estimates a 3D skeleton of the subject in a plurality of frames on the basis of a plurality of the multi-viewpoint images continuously captured. The generation unit generates a volumetric moving image of the subject as the 3D data on the basis of a 3D skeleton of the subject in the plurality of frames.

Thus, the video processing device moves only skeleton data using a rig-containing model and generates volumetric on the basis of the skeleton data, thereby easily creating a volumetric moving image which is continuous volumetric video.

Furthermore, in a case where second 3D data generated in advance has a defect, the estimation unit estimates a 3D skeleton of a subject in a frame of a multi-viewpoint image corresponding to the second 3D data. The application unit applies a 3D skeleton of the subject estimated by the estimation unit to a subject in a frame of a multi-viewpoint image corresponding to the second 3D data. The generation unit generates 3D data of a subject to which a 3D skeleton is applied by the application unit instead of the second 3D data. Furthermore, the generation unit generates third 3D data by taking a logical sum of the second 3D data and 3D data of the subject.

Thus, since the video processing device performs retargeting on the basis of the skeleton data, it is possible to generate appropriate volumetric for a subject in a frame in which noise is generated by separation processing or the like.

Furthermore, on the basis of the multi-viewpoint images including a plurality of subjects, the estimation unit estimates a 3D skeleton of each of the plurality of subjects. The application unit applies a 3D skeleton of each of the plurality of subjects to each of the subjects included in other images different from the multi-viewpoint images. The generation unit generates 3D data of each subject to which a 3D skeleton is applied by the application unit.

Thus, the video processing device can similarly generate the volumetric for a plurality of subjects. As a result, the video processing device can mitigate a decrease in accuracy of a shape due to occlusion between the subjects, and enables position adjustment at the time of rendering such that a separate model for each subject is arbitrarily arranged.

Furthermore, in a case of applying a 3D skeleton of each of the plurality of subjects to each subject, the application unit specifies data of an application destination subject by taking a logical product of data corresponding to the subject separated from a background between a plurality of images including at least one subject.

Thus, the video processing device can appropriately specify a silhouette of each subject by specifying a subject using a logical product in a frame in which the subjects overlap each other.

Furthermore, the generation unit corrects a shape of the subject specified to generate 3D data of the subject on the basis of a 3D skeleton after correction.

Thus, the video processing device can perform modeling with a natural shape original to a subject by performing correction.

Furthermore, the generation unit generates 3D data in which the respective subjects to which a 3D skeleton is applied by the application unit are integrated into one.

Thus, the video processing device can also generate a volumetric moving image including a plurality of subjects by using the video processing according to the embodiment. According to the video processing device, since a position and a size of a model of each subject can be arbitrarily changed, it is possible, for example, to promote a user to utilize a volumetric moving image.

Note that the present technique can also have the following configurations.
(1) A video processing device comprising:
   an estimation unit that estimates a 3D skeleton of a subject on the basis of multi-viewpoint images obtained by shooting the subject from a plurality of viewpoints;
   an application unit that applies a 3D skeleton of the subject estimated by the estimation unit to the subject included in other image different from the multi-viewpoint images and separated from a background in the image; and
   a generation unit that generates 3D data of a subject to which a 3D skeleton is applied by the application unit.
(2) The video processing device according to (1), wherein
   on the basis of a rig attached to the subject included in the other image, the application unit applies a 3D skeleton of the subject to the subject.
(3) The video processing device according to (1) or (2), wherein
   the estimation unit estimates a 3D skeleton of the subject in a plurality of frames on the basis of a plurality of the multi-viewpoint images continuously captured; and
   the generation unit generates a volumetric moving image of the subject as the 3D data on the basis of a 3D skeleton of the subject in the plurality of frames.
(4) The video processing device according to any one of (1) to ( ) wherein
   in a case where second 3D data generated in advance has a defect,
   the estimation unit estimates a 3D skeleton of a subject in a frame of a multi-viewpoint image corresponding to the second 3D data,
   the application unit applies a 3D skeleton of the subject estimated by the estimation unit to a subject in a frame of a multi-viewpoint image corresponding to the second 3D data, and
   the generation unit generates 3D data of a subject to which a 3D skeleton is applied by the application unit instead of the second 3D data.
(5) The video processing device according to (4), wherein the generation unit generates third 3D data by taking a logical sum of the second 3D data and 3D data of the subject.
(6) The video processing device according to any one of (1) to (5), wherein
   on the basis of the multi-viewpoint images including a plurality of subjects, the estimation unit estimates a 3D skeleton of each of the plurality of subjects,
   the application unit applies a 3D skeleton of each of the plurality of subjects to each of the subjects included in other images different from the multi-viewpoint images, and
   the generation unit generates 3D data of each subject to which a 3D skeleton is applied by the application unit.
(7) The video processing device according to (6), wherein,
   in a case of applying a 3D skeleton of each of the plurality of subjects to each subject,
   the application unit specifies data of an application destination subject by taking a logical product of data corresponding to the subject separated from a background between a plurality of images including at least one subject.
(8) The video processing device according to (7), wherein
   the generation unit corrects a shape of the subject specified to generate 3D data of the subject on the basis of a 3D skeleton after correction.
(9) The video processing device according to (6) or (7), wherein
the generation unit generates 3D data in which the respective subjects to which a 3D skeleton is applied by the application unit are integrated into one.
(10) A video processing method including
   execution by a computer to:
   estimate a 3D skeleton of a subject on the basis of multi-viewpoint images obtained by shooting the subject from a plurality of viewpoints;
   apply a 3D skeleton of the subject estimated to the subject included in other image different from the multi-viewpoint images and separated from a background in the image; and
   generate 3D data of a subject to which the 3D skeleton is applied.
(11) A program for causing a computer to function as a video processing device,
   wherein the video processing device includes:
      an estimation unit that estimates a 3D skeleton of a subject on the basis of multi-viewpoint images obtained by shooting the subject from a plurality of viewpoints;
      an application unit that applies a 3D skeleton of the subject estimated by the estimation unit to the subject included in other image different from the multi-viewpoint images and separated from a background in the image; and
      a generation unit that generates 3D data of a subject to which a 3D skeleton is applied by the application unit.

### REFERENCE SIGNS LIST

100 VIDEO PROCESSING DEVICE
110 COMMUNICATION UNIT
120 STORAGE UNIT
130 CONTROL UNIT
131 ACQUISITION UNIT
132 ESTIMATION UNIT
133 APPLICATION UNIT
134 GENERATION UNIT
135 OUTPUT UNIT

1. A video processing device comprising:
an estimation unit that estimates a 3D skeleton of a subject on the basis of multi-viewpoint images obtained by shooting the subject from a plurality of viewpoints;
an application unit that applies a 3D skeleton of the subject estimated by the estimation unit to the subject included in other image different from the multi-viewpoint images and separated from a background in the image; and
a generation unit that generates 3D data of a subject to which a 3D skeleton is applied by the application unit.

2. The video processing device according to claim 1, wherein
on the basis of a rig attached to the subject included in the other image, the application unit applies a 3D skeleton of the subject to the subject.

3. The video processing device according to claim 1, wherein
the estimation unit estimates a 3D skeleton of the subject in a plurality of frames on the basis of a plurality of the multi-viewpoint images continuously captured; and
the generation unit generates a volumetric moving image of the subject as the 3D data on the basis of a 3D skeleton of the subject in the plurality of frames.

4. The video processing device according to claim 1, wherein
in a case where second 3D data generated in advance has a defect,
the estimation unit estimates a 3D skeleton of a subject in a frame of a multi-viewpoint image corresponding to the second 3D data,
the application unit applies a 3D skeleton of the subject estimated by the estimation unit to a subject in a frame of a multi-viewpoint image corresponding to the second 3D data, and
the generation unit generates 3D data of a subject to which a 3D skeleton is applied by the application unit instead of the second 3D data.

5. The video processing device according to claim 4, wherein
the generation unit generates third 3D data by taking a logical sum of the second 3D data and 3D data of the subject.

6. The video processing device according to claim 1, wherein
on the basis of the multi-viewpoint images including a plurality of subjects, the estimation unit estimates a 3D skeleton of each of the plurality of subjects,
the application unit applies a 3D skeleton of each of the plurality of subjects to each of the subjects included in other images different from the multi-viewpoint images, and
the generation unit generates 3D data of each subject to which a 3D skeleton is applied by the application unit.

7. The video processing device according to claim 6, wherein,
in a case of applying a 3D skeleton of each of the plurality of subjects to each subject,
the application unit specifies data of an application destination subject by taking a logical product of data corresponding to the subject separated from a background between a plurality of images including at least one subject.

8. The video processing device according to claim 7, wherein
the generation unit corrects a shape of the subject specified to generate 3D data of the subject on the basis of a 3D skeleton after correction.

9. The video processing device according to claim 6, wherein
the generation unit generates 3D data in which the respective subjects to which a 3D skeleton is applied by the application unit are integrated into one.

10. A video processing method including
execution by a computer to:
estimate a 3D skeleton of a subject on the basis of multi-viewpoint images obtained by shooting the subject from a plurality of viewpoints;
apply a 3D skeleton of the subject estimated to the subject included in other image different from the multi-viewpoint images and separated from a background in the image; and
generate 3D data of a subject to which the 3D skeleton is applied.

11. A program for causing a computer to function as a video processing device,
wherein the video processing device includes:
an estimation unit that estimates a 3D skeleton of a subject on the basis of multi-viewpoint images obtained by shooting the subject from a plurality of viewpoints;
an application unit that applies a 3D skeleton of the subject estimated by the estimation unit to the subject included in other image different from the multi-viewpoint images and separated from a background in the image; and
a generation unit that generates 3D data of a subject to which a 3D skeleton is applied by the application unit.
